(19) United States
(12) Patent Application Publication
(10) Pub. No.: US 2002/0116487 A1
(43) Pub. Date: Aug. 22, 2002

(54) Network management method

(76) Inventors: Kohei Iseda, Kawasaki (JP); Takafumi Chujo, Kawasaki (JP); Takao Ogura, Kawasaki (JP)

Correspondence Address: Katten Muchin Zavis Rosenman, 575 Madison Avenue, New York, NY, 10022-2585, US

(21) Appl. No.: 10/123,107

(22) Filed: Apr. 11, 2002

Related U.S. Application Data
(63) Continuation of application No. PCT/JP99/05683, filed on Oct. 14, 1999.

(51) Int. Cl. G06F 15/173; G06F 17/30; G06F 12/00

(52) U.S. Cl. 709/223; 707/202

(57) ABSTRACT

This invention provides a network management system with a route predicted beforehand through which a control IP packet is to be transmitted, and while setting up permission of control in a communication apparatus that checks permission of control, if the control IP packet is to be permitted, when the communication apparatus which received the control IP packet checks the permission of control with the network management system, permission of control is set up in other communication apparatuses on the predicted route over which the control IP packet is to be transmitted. For this reason, the number of checking messages of the control permission from the communication apparatuses which received the control IP packet can be reduced, while the amount of processing, such as a database search in a network management system and updating, can be reduced, and control permission to a control IP packet can be checked speedily.

### TECHNICAL FIELD

The present invention relates to a network management method, and especially relates to the network management method of a network that controls a communication apparatus by transmitting a control IP (Internet Protocol) packet, wherein the communication apparatus checks with a management system whether or not a control is permissible.

### BACKGROUND TECHNOLOGY

In recent years, a network management method that accepts only a control relative to an IP flow that is permitted by a contract, a standard, etc., is required in an IP network.

As target of the control, a control of guaranteeing a bandwidth by a bandwidth reservation packet for realizing quality assurance, such as a bandwidth guarantee is being studied.

Examples of realizing the control of a communication apparatus by transmitting an IP packet include a bandwidth reservation according to IETF standard RFC2205 “Resource Reservation protocol (RSVP)”, and the like.

In this case, a first method is such that if a communication apparatus (e.g., a router) receives a control packet in compliance with an IP flow, the communication apparatus checks with a database that holds permission data in a network management system whether or not a set up may be performed, and if it is a control IP packet relative to a permitted IP flow, the control is set up (for example, reservation of a bandwidth, if it is RSVP), and the control IP packet is transmitted to a next communication apparatus which will repeat the same procedure of checking with the network management system about permission of the control.

Other than the above, a second method is structured such that

a database is provided in a network management system for storing setting (IP packet routing information) of all IP transmissions in an IP network,

when IP packet routing information is updated in a communication apparatus, data-in the network management system is simultaneously updated,

when a first communication apparatus checks whether a set-up is permissible with the database that holds permission data, it simultaneously searches the database that holds IP transmitting settings (IP packet routing information), and

a set-up is performed on all communication apparatuses on a route through which a control IP packet will be transmitted, such that a control by the control IP packet for the IP flow concerned is permitted, thereby, checking with the network management system that stores permission data is not performed when the control IP packet arrives at each communication apparatus.

However, by the first method above, in a large network, the number of inquiries made from the apparatuses to a permission database of the network management system increases, and there is a problem of network congestion by increased traffic from the inquiries and increased time taken in control due to the increase in the number of database searches.

Further, in the second method where a permission to control by the control IP packet is set up on the communication apparatuses on the route by checking whether or not control is permitted with the communication apparatus that received the control IP packet in the first place, and by searching the IP transmitting set-up (IP packet routing information), an increase in network congestion by informing the IP packet routing information, generated in the communication apparatus according to an increase in network congestion and according to movement of a source terminal and a destination terminal, should be reflected to the IP transmitting set-up data in the network management system cause difficulties in maintaining consistency between data in the communication apparatus and data in the network management system, degrading desired operations.

### DISCLOSURE OF INVENTION

This invention generally aims at offering a network management method, which can reduce traffic due to changes in routing table, and can reduce the number of checking messages as to control by the control IP packet.

In order to attain this object, the present invention provides a network management method whereby a permission of control is managed by the network management system in case of controlling each communication apparatus included in the network by transmitting a control IP packet, which is structured such that

a predicted route through which the control IP packet is to be transmitted is prepared in the network management system beforehand, and

when a communication apparatus that receives the control IP packet checks the network management system as to whether or not the control is permitted, if the IP packet control is to be permitted, the network management system sets up a permission of the control on the communication apparatus which checked the permission of the control, while the permission is also set up on other communication apparatuses on the predicted route through which the control IP packet will be transmitted.

According to the network management method as above described, an amount of processing such as database search, updating and the like, in the network management system is reduced, while the number of checking messages from communication apparatuses that receive the control IP packet for a control permission are reduced, thereby, a high-speed confirmation of the control permission is realized.

### BRIEF EXPLANATION OF THE DRAWINGS

Other objects, features and advantages of the present invention will become still clearer by reading the following detailed explanation, referring to the attached drawings.

FIG. 1 is a system configuration drawing for explaining the principle of a method of this invention.

FIG. 2 is a flowchart of control processing which a network management system performs.

FIG. 3 is a structure drawing of an embodiment of a control permission database of a control IP packet, which a network management system stores.

FIG. 4 is a drawing showing connection information about apparatuses of a network.

FIG. 5 is a drawing showing an example of a data structure of the embodiment of a predicted route, and the predicted route and an actual transmitting route of a control IP packet.

FIG. 6 is a drawing showing a system configuration and operation of the first embodiment of the method of the present invention.

FIG. 7 is a flowchart of a first embodiment of control processing which a network management system 40 performs.

FIG. 8 is a structure drawing of an embodiment of each of a control IP packet for bandwidth reservation, a reservation permission checking message, and a permission message.

FIG. 9 is a structure drawing of an embodiment of a reservation permission database.

FIG. 10 is a drawing showing examples of a predicted route database.

FIG. 11 is a flowchart of the first embodiment of processing which a communication apparatus performs.

FIG. 12 is a flowchart of a second embodiment of control processing which the network management system 40 performs.

FIG. 13 is a flowchart of a third embodiment of control processing that the network management system 40 performs.

FIG. 14 is a flowchart of a fourth embodiment of control processing that the network management system 40 performs.

FIG. 15 is a drawing showing a system configuration and operation of a 5th embodiment of the method of this invention.

FIG. 16 is a flowchart of a 6th embodiment of control processing that the network management system 40 performs.

FIG. 17 is a flowchart of a 7th embodiment of control processing that the network management system 40 performs.

### BEST FORM OF THE INVENTION

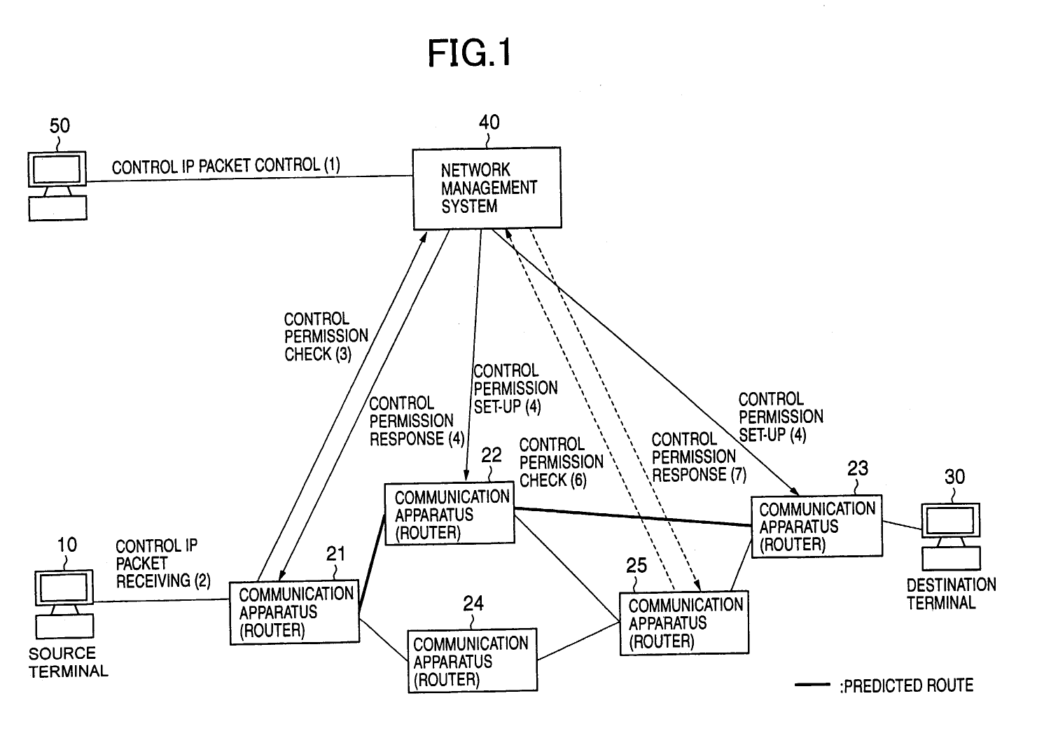

FIG. 1 is a system configuration drawing showing the principle of the method of this invention. In this drawing, when a source terminal 10 requires control of a communication apparatus corresponding to an IP flow, communication is started after transmitting an address of the source terminal, an address of a destination terminal, a content of control and a control IP packet that includes a control ID, and receiving a confirmation packet of control execution.

When communication apparatuses 21-25 receive the control IP packet, the address of the source terminal, the address of the destination terminal and the control ID are checked, and if a control has already been set up to the apparatuses, the control IP packet is transmitted to a next communication apparatus.

If the control has not been set up, a check is performed with a network management system 40 as to whether the control may be set up. If the control is permitted, the control is set up, and then, the control IP packet is transmitted to the next communication apparatus.

A control terminal 50 sets a permission of the control in reference to an address of a source terminal, an address of a destination terminal, a control item and the like, in the network management system 40.

When the control IP packet is transmitted from the source terminal 10, and received by the communication apparatus 21, the network management system 40 receives a checking message from the communication apparatus 21 as to whether or not a setup of a control is permissible, and searches a database about permission of control by the control IP packet. When a search result is that-the control is permissible, a control permission message is transmitted to the communication apparatus 21 which checked the permission of the control, and the control permission message is also transmitted by the control IP packet to the communication apparatuses 22 and 23 which are located on a transmitting route of the control IP packet to the destination terminal 30, which route was predicted beforehand from connection information of the communication apparatuses, such that the permission of the control is set at the communication apparatuses 22 and 23.

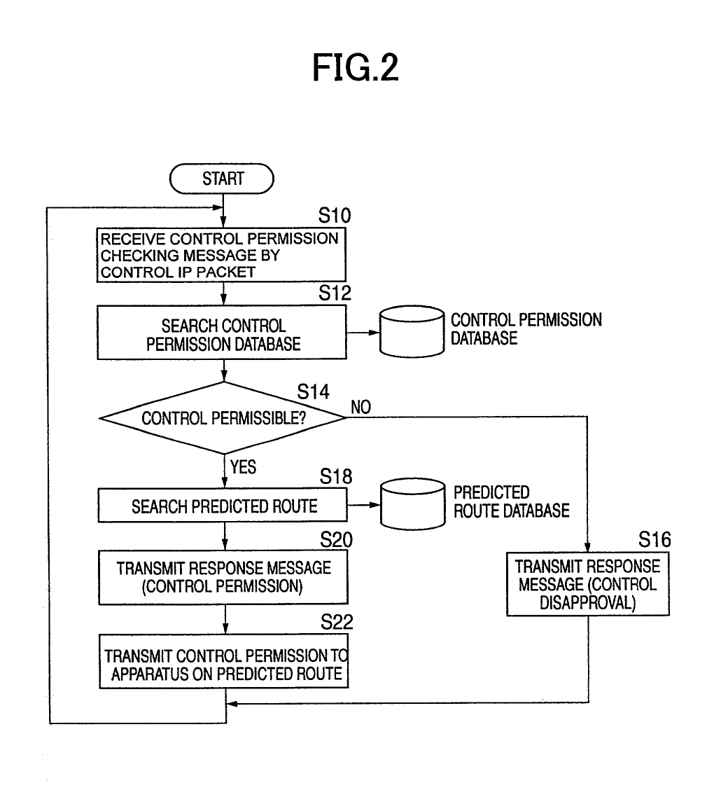

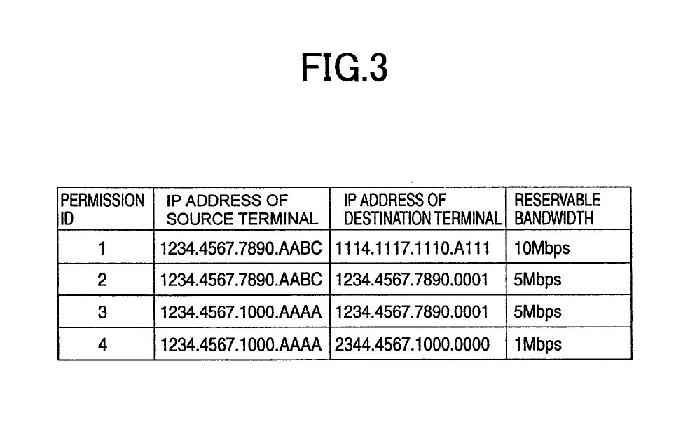

FIG. 2 shows a flowchart of control processing that the network management system 40 performs. Further, a structure of an embodiment of a control permission database for the control IP packet, which the network management system includes, is shown in FIG. 3.

In FIG. 2, the network management system 40 receives a checking message relative to permission of control by the control IP packet at a step S10, and at a step S12, searches the control permission database, an example of structure of which is shown in FIG. 3. Upon checking an address of a source terminal, an address of a destination terminal and a control ID of the IP packet, as a result of the search executed at step S12, whether or not control is permissible is determined at a step S14. If it is not permitted, a response message of control disapproval is transmitted at a step S16.

Further, if it is permitted, a predicted route database is searched at a step S18, and the response message of control permission is transmitted at a step S20. Next, the response message of the permission of the control by this control IP packet is transmitted to communication apparatuses located on the transmitting route of the control IP packet through the destination terminal 30 (predicted route) at a step S22.

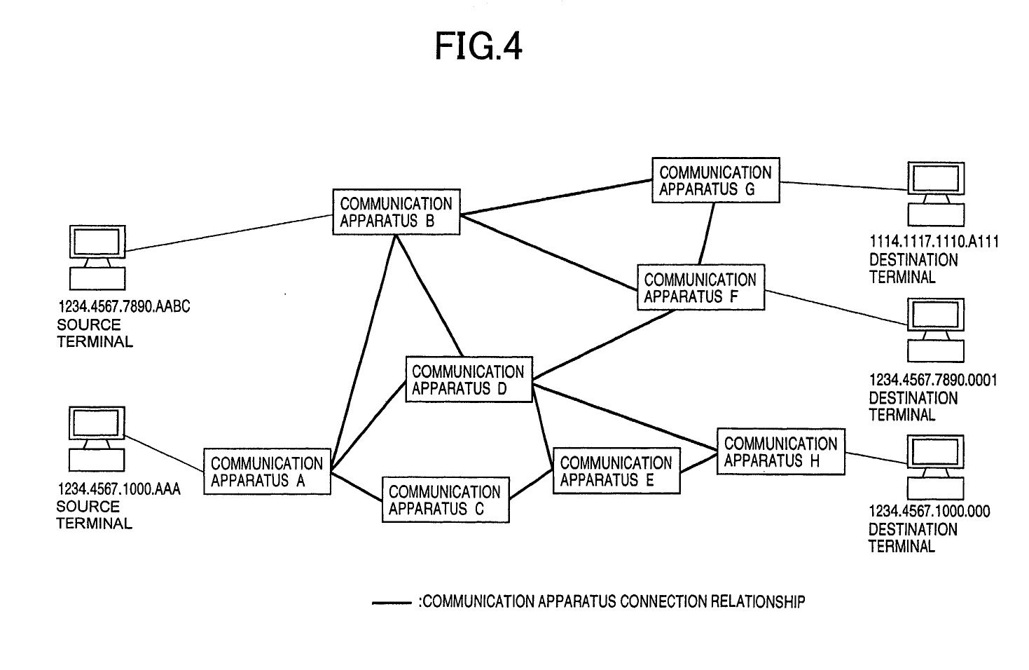

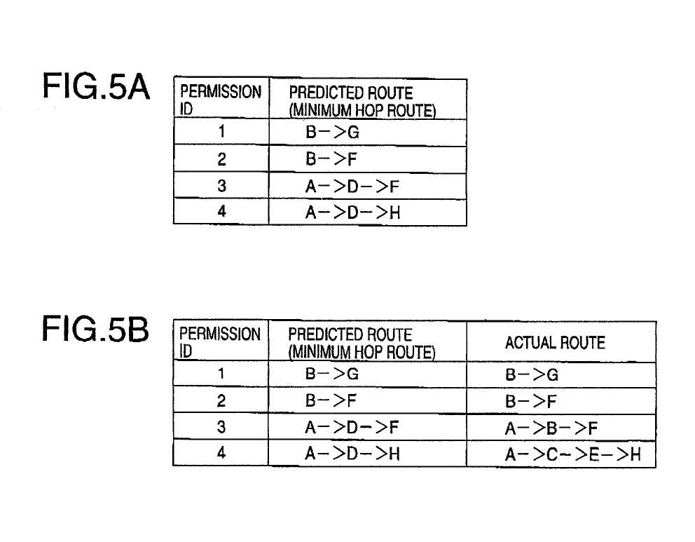

Further, a data structure of an embodiment of the predicted route is indicated by (A) in FIG. 5, which is obtained by using Dijkstra's algorithm given in E. W. Dijkstra, “A note on two problems in connection with graphs”, Numer.Math., 1 (1959) PP.269-271 and the like, in the case that a smallest quantity of hops (the number of the communication apparatuses in a route being the minimum) from the communication apparatus that received the control IP packet in the beginning to the destination terminal is predicted in reference to the apparatus connection information of the network shown in FIG. 4. Further, an example of the predicted route and actual transmitting route (real route) of the control IP packet is indicated by (B) in FIG. 5.

In reference to FIG. 1, when the communication apparatus 21 connected to the source terminal 10 receives the control IP packet for control of the communication apparatus from the source terminal 10 (2), the communication apparatus 21 transmits to the network management system 40 (3) a-message for checking whether the control IP packet from a source terminal has a permission to control by a control IP packet.

The network management system 40 has already received the control IP packet beforehand from the control terminal 50 (1), which is stored in a database in the network management system 40. The network management system 40 searches control permission data that defines whether or not the control by the control IP packet is permitted. If the control IP packet from the source terminal is a control IP packet by which the control is permitted, a response notifying a permission to control by the control IP packet is transmitted to the communication apparatus 21 (4), while the message notifying the permission of control by the control IP packet is also transmitted to the communication apparatuses 22 and 23 on a route that is predicted beforehand to be a transmitting route of the control IP packet (4).

If the control IP packet is transmitted to a communication apparatus 25 that is not on the predicted route, that is, if the control IP packet arrives at a communication apparatus where the permission to control by the control IP packet has not been set up, the communication apparatus 25 checks with the network management system 40 whether a control by the control IP packet is permitted (6), and if a permission is granted (7), the control IP packet is transmitted to the next communication apparatus 23. Here, a number in parentheses corresponds to a path number in parentheses in FIG. In this manner, if the prediction of the transmitting route of the control IP packet is correct, reduction in the checking messages relative to permission from the subsequent communication apparatuses that receive the control IP packet is realized, an amount of traffic between the communication apparatuses and the network management system 40 is reduced, and an amount of processing such as a database search of the network management system is reduced.

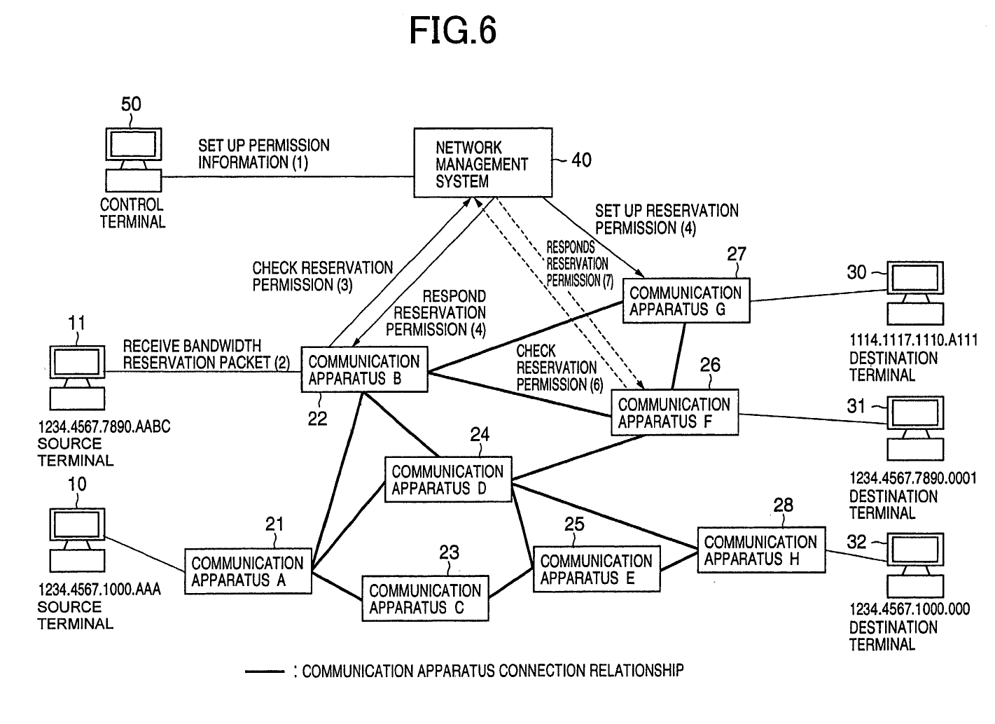

FIG. 6 shows system configuration and operation of a first embodiment of the method of the present invention. The first embodiment represents an example wherein a bandwidth reservation packet is used as the control IP packet. In FIG. 6, source terminals 10 and 11 are connected to communication apparatuses 21 and 22, respectively. Communication apparatuses 21-28 are members of a network. Further, communication apparatuses 26, 27, and 28, are connected to destination terminals 30, 31, and 32, respectively. The communication apparatuses 21-28, being the members of the network, are managed by a network management system 40. A control terminal 50 sets the network management system 40 with control permission information of a control IP packet.

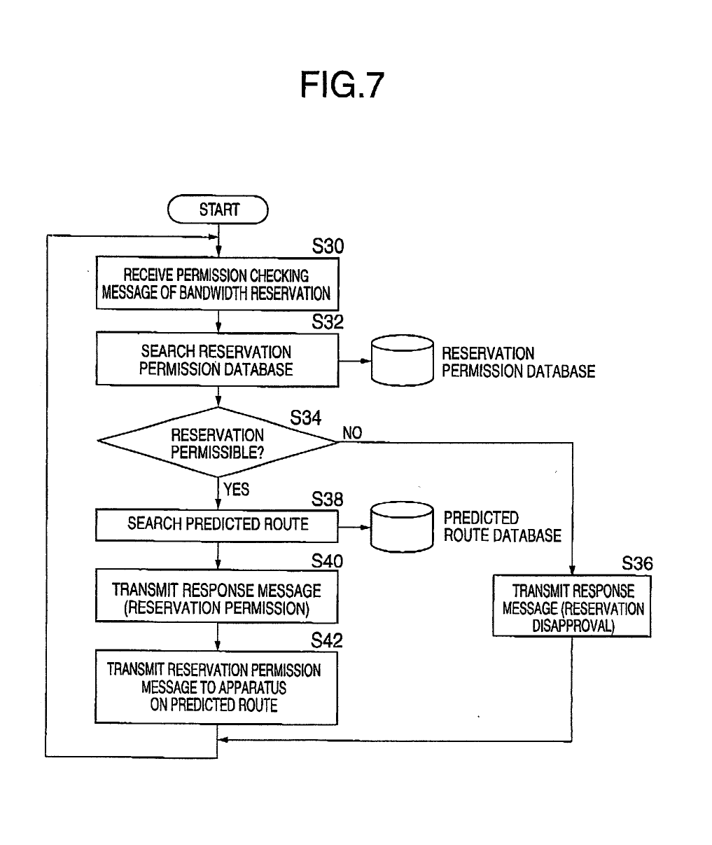

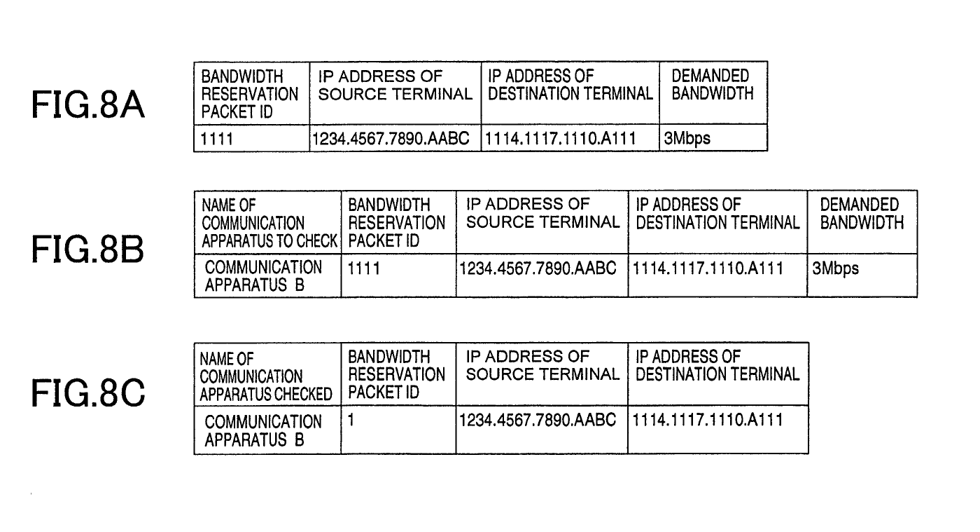

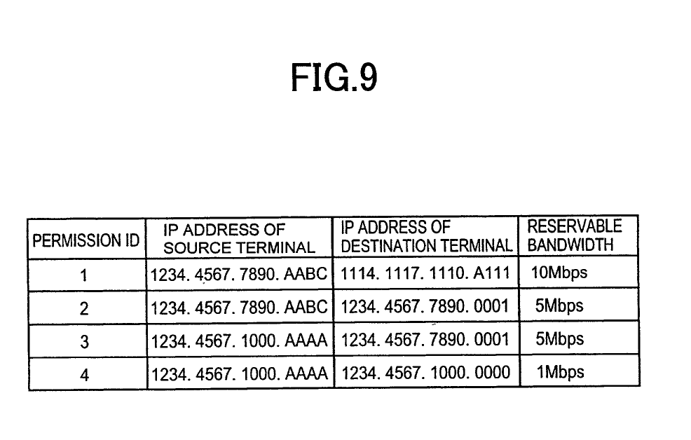

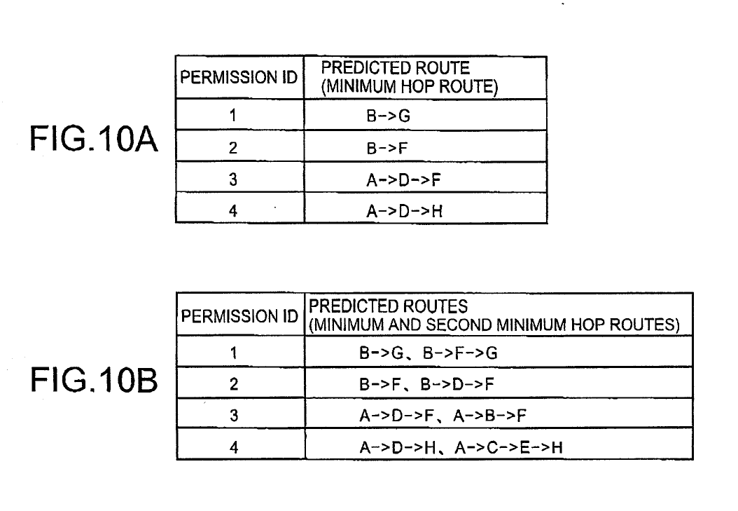

FIG. 7 shows a flowchart of the first embodiment of the control processing performed by the network management system 40. Further, an embodiment of structures of the control IP packet of bandwidth reservation, a reservation permission checking message, and a permission message are indicated by (A), (B), and (C) in FIG. 8, respectively. FIG. 9 shows an embodiment of a structure of a reservation permission database. Examples of a predicted route database are indicated by (A) and (B) in FIG. 10.

In reference to FIG. 7, the network management system 40 receives a reservation permission checking message of the control IP packet as indicated by (B) in FIG. 8 at a step S30, and searches the reservation permission database that is structured, for example, as shown in FIG. 9, as provided by the control permission checking message at a step S32. Upon checking an address of a source terminal, an address of a destination terminal and a control ID, whether control is permitted is determined at a step S34, and if it is not permissible, a response message of reservation disapproval is transmitted at a step S36.

Further, if it is permissible, the predicted route database, such as indicated by (A) and (B) in FIG. 10, is searched at a step S38, and a response message of reservation permission is transmitted at a step S40. Next, the response message of reservation permission by this control IP packet is transmitted to communication apparatuses on a transmitting route of the control IP packet through the destination terminal 30, which is predicted at a step S42 (predicted route).

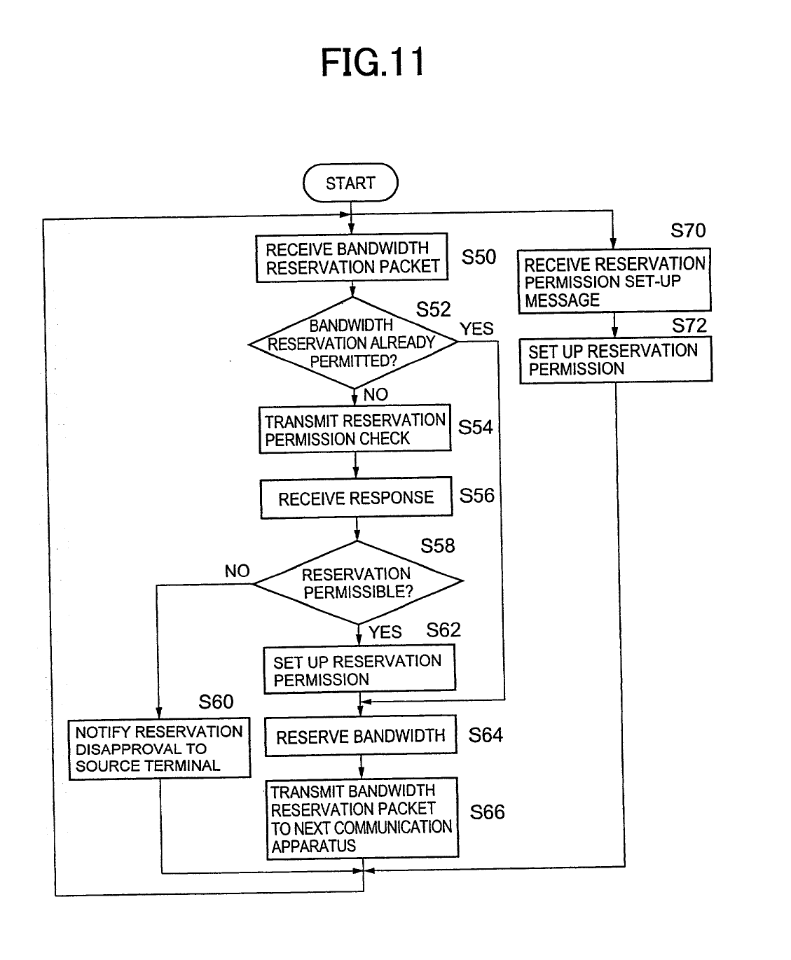

FIG. 11 shows a flowchart of the first embodiment of the processing that the communication apparatus performs. When a bandwidth reservation packet is transmitted, this bandwidth reservation packet will be received at a step S50, and whether the bandwidth reservation has been already granted is checked at a step S52. If the bandwidth reservation has been granted, the process moves to step S64. If the bandwidth reservation has not been granted, the process moves to step S54 and a reservation permission checking message is transmitted to the network management system 40.

Next, a response message from the network management system 40 is received at a step S56, and whether it is the response message of reservation permission is determined at a step S58. If it is not a response message of reservation permission and the reservation should be rejected, reservation disapproval is provided to a source terminal at a step S60. On the other hand, if it is a response message of reservation permission, and the reservation is permissible, reservation permission is set up at a step S62, then, this bandwidth is reserved at a step S64, and then, a bandwidth reservation packet is transmitted to a next communication apparatus at a step S66.

Further, when the message of reservation permission is transmitted from the network management system 40 to a communication apparatus as being on the predicted route, the message of this reservation permission is received at a step S70, and reservation permission is set up according to this message at a step S72.

In reference to FIG. 6, when the communication apparatus 22 connected to the source terminal 11 having an IP address “1234.4567.7890.AABC” receives a bandwidth reservation packet as indicated by (A) in FIG. 8 from the source terminal 11 (2), the communication apparatus 22 performs processing according to the flowchart shown in FIG. 11, checks whether the reservation by the received bandwidth reservation packet is permitted, if the reservation is not permitted, a check of the reservation permission as shown in FIG. 8 (B) is transmitted to the network management system (3). Here, a number in parentheses corresponds to a path number in parentheses in FIG. 6.

The network management system 40 performs processing according to the flowchart shown in FIG. 7, and searches the reservation permission database shown in FIG. 9. Because contents of the bandwidth reservation packet indicated by (A) of FIG. 8 have been permitted as a permission ID1 in FIG. 9, the network management system 40 transmits a permission message of the reservation permission response shown by (C) in FIG. 8 to the communication apparatus 22 (4), while the permission message of the reservation permission response is transmitted also to the communication apparatus 27 on a predicted route corresponding to the permission ID1 indicated by (A) in FIG. 10, which is extracted from the search result of the reservation permission database (4).

The communication apparatus 22 which receives the reservation permission message stores this information as data of a reservation permission setup while reserving the bandwidth. Further, the communication apparatus 27 receives the reservation permission message, stores this information as data of a reservation permission setup, and waits for a bandwidth reservation packet to arrive.

Here, according to the IETF standard RFC2205 “Resource Reservation protocol” (RSVP), a packet indicating reservation status is repeatedly transmitted at a certain fixed interval while the bandwidth is reserved. After this packet stops arriving, each communication apparatus clears the data of the reservation permission setup after the elapse of a fixed amount of time.

If a prediction of the transmitting route of the bandwidth reservation packet can be performed with sufficient precision, reduction can be attained in the checking messages of the reservation permission to the network management system 40 from the communication apparatuses that receive subsequent bandwidth reservation packets, and reduction can be attained in an amount of traffic between the communication apparatuses and the network management system 40. In addition, an amount of processing, such as a database search of the network management system 40, can be reduced.

Here, a description will follow about the case where a control IP packet is as a bandwidth reservation packet, and a shortest route is considered to be a minimum hop route, being as a predicted route. The predicted route indicated by (A) in FIG. 10 is predicted route data of the minimum hop (the smallest number of relaying communication apparatuses) from a communication apparatus that receives a bandwidth reservation packet to a destination terminal, which is obtained beforehand by Dijkstra's algorithm and the like, using the connection information of each communication apparatus in the network as shown in FIG. 6, and assuming that distances between communication apparatuses are the same.

At a time of setting up and the like of the communication apparatus, a predicted route is prepared in the database, and a permission ID is assigned when permission information is received from the control terminal 50 (1). Transfer route information of an IP network is calculated autonomously and in a distributed manner, that is, each communication apparatus acquires information using a protocol IETF RFC2328 “OSPF version 2” and the like, and calculates a least delay route as the shortest route using Dijkstra's algorithm, in case of the occurrence of an addition and a failure of a communication apparatus, a network congestion and the like. For this reason, the transmitting route information and the minimum hop of the connection status of the communication apparatuses take a similar result when there is no failure, no network congestion and the like. This is because under such favorable conditions delay in a communication apparatus is greatest, making the least delay route to be the same as the minimum hop route in many cases.

In this manner, a precise prediction of the transmitting route of a bandwidth reservation packet is realized, which enables a reduction in the checking messages of the permission from the subsequent communication apparatuses which receive the bandwidth reservation packet, resulting in a reduction in the amount of traffic between the communication apparatuses and the network management system 40, further resulting in a reduction in the amount of processing such as a database search of the network management system 40. Here, the shortest route; a route having the shortest physical distance, etc., can be considered besides the least delay route.

Next, a description follows about the case where the predicted route is selected from a plurality of routes starting from the shortest route, where the minimum hop is taken as the shortest route. The predicted route indicated by (B) in FIG. 10 is the predicted route data in the case of making the minimum hop and a second shortest route as the predicted routes from the connection information of each communication apparatus as shown in FIG. 6. The predicted route is prepared in a database at the time of setting up and the like of the communication apparatus, and a permission ID is assigned when permission information is received from the control terminal 50 (1). Transfer route information of an IP network is calculated autonomously and in a distributed manner, that is, each communication apparatus acquires information using a protocol IETF RFC2328 “OSPF version 2” and the like, and calculates a least delay route as the shortest route using Dijkstra's algorithm, upon occurrence of an addition and a failure of a communication apparatus, a network congestion and the like. For this reason, the transmitting route information and the minimum hop of the connection status of the communication apparatuses take a similar result when there is no failure, no network congestion and the like.

By having the plurality of predicted routes, the predicted route database becomes larger, however, precision of the prediction of the transmitting route of the bandwidth reservation packet is improved, enabling a reduction in the checking messages of the permission to the network management system 40 from the subsequent communication apparatuses that receive the bandwidth reservation packet, further enabling a reduction in the amount of traffic between the communication apparatuses and the network management system 40.

Another embodiment is such that IP packet routing information in the communication apparatus at a certain time, defined by IETF RFC2011 “SNMPv2 Management Information Base for the Internet Protocol using SMIv2” and the like is read using IETF RFC1905 “Protocol Operation for Version 2 of the Simple Network Management Protocol (SNMPv2)” and the like, thereby a route configured by connecting primary candidates of network sections is used as the predicted route.

In this manner, although an amount of traffic for reading increases, a route prediction with a higher precision is attained.

Further another embodiment is that IP packet routing information in the communication apparatus at a certain time, defined by IETF RFC2011 “SNMP v2 Management Information Base for the Internet Protocol using SMIv2”, and the like is read by using IETF RFC1905 “Protocol Operation for Version 2 of the Simple Network Management Protocol (SNMPv2)” and the like, thereby routes are configured by connecting primary candidates and second candidates and the like of a next hop, and routes that include more than a predetermined quantity of the second and lower candidates (e.g. a route that includes more than five pieces of the second candidates of a next hop) are excluded from the predicted route to be used.

Because the second or lower candidates of the next hop are used only in the case of a failure of a communication apparatus and the like, a set-up actually including two or more second or lower-level candidates has a low probability of occurring, enabling an efficient reduction in the predicted routes, realizing a high precision route prediction, and suppressing growth of the prediction route database.

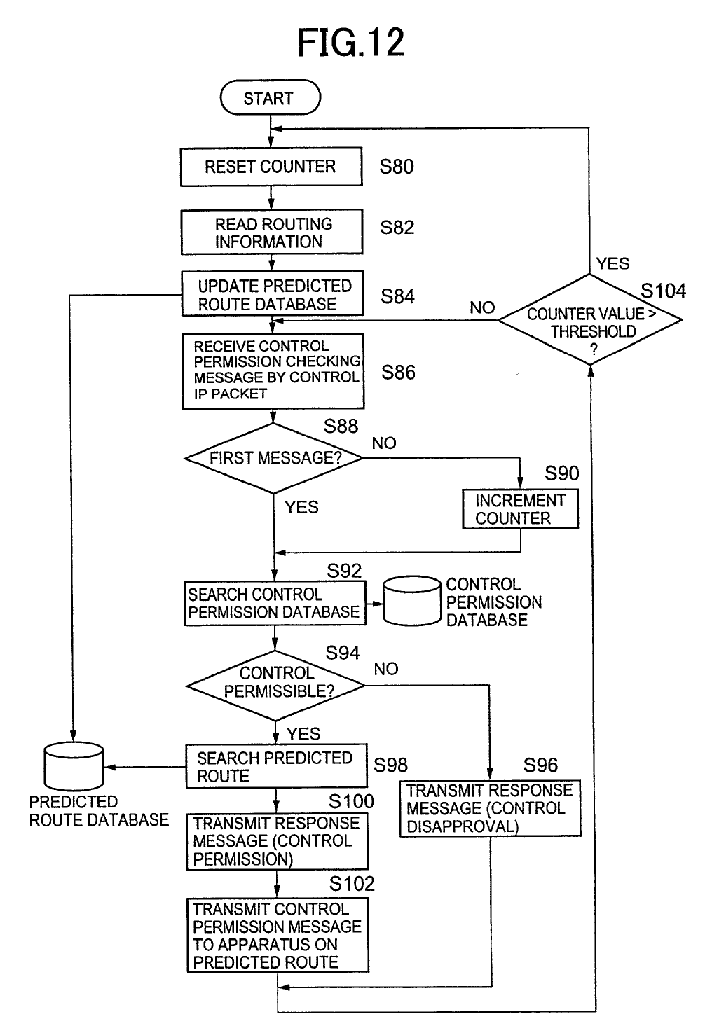

FIG. 12 shows a flowchart of the second embodiment of the control processing which the network management system 40 performs.

In the drawing, the network management system 40 initially resets a counter to 0 at a step S80. Next, at a step S82, packet routing information in a communication apparatus, defined by IETF RFC2011 “SNMP v2 Management Information Base for the Internet Protocol using SMIv2” and the like is read using IETF RFC1905 “Protocol Operation for Version 2 of the Simple Network Management Protocol (SNMPv2)” and the like. Then, at a step S84, a route configured by connecting primary candidates of a next hop is taken as a predicted route, which is stored in the predicted route database.

Next, at a step S86, the network management system 40 receives a permission checking message of control by an arrival of a control IP packet, and at a step 88, determines whether this control permission checking message is a first message (control permission checking message from the communication apparatus to which the source terminal is connected). And only when it is not the first message, the counter is incremented at a step S90. That is, the count value of the counter increases as a difference between the predicted route and the actual route becomes large.

Then, the control permission database of the structure as shown in FIG. 3, for example, is searched by this control permission checking message at a step S92. Upon checking an address of a source terminal, an address of destination terminal, and a control ID, whether or not the control is permissible is determined in this search at a step S94. If it is not permissible, a response message of control disapproval is transmitted at a step S96.

Further, if it is permissible, the predicted route database is searched at a step S98, and a response message of control permission is transmitted at a step S100. Next, at a step S102, a response message of the control permission by this control IP packet is transmitted to the communication apparatuses on an IP packet transmitting route (predicted route) down to the destination terminal 30.

Next, whether the counted value of the counter exceeds a predetermined threshold value is checked at a step S104. If it does not exceed the threshold, the process moves to the step S86. If it exceeds the threshold, the process progresses to the step S80. That is, when the counted value exceeds the threshold, because the difference between the predicted route and the actual route has become large, the predicted route database is updated so that it is in line with the actual route.

In this manner, the route prediction with a high precision consistent with prevailing network conditions is then attained by updating the predicted route database so that it is in line with the actual route when the difference between the predicted route and the actual route has become large, causing the counted value to exceed the threshold.

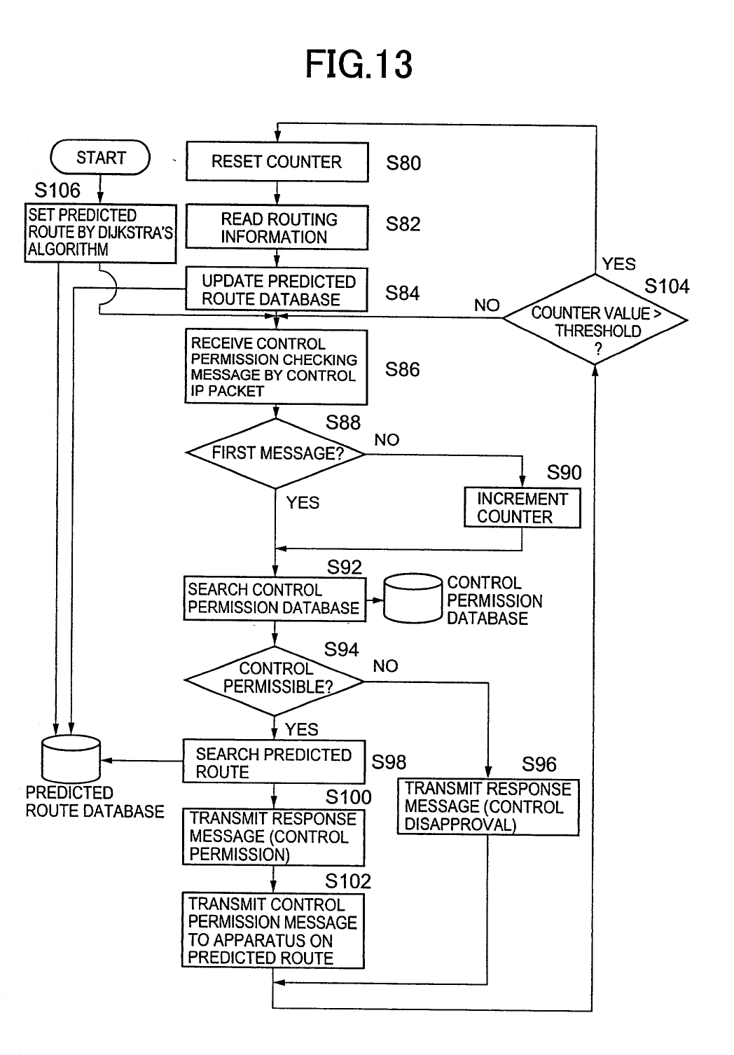

FIG. 13 shows a flowchart of the third embodiment of the control processing which the network management system 40 performs. In the drawing, the same reference number is given to the same step as in FIG. 12.

In FIG. 13, initially at a step S106, the network management system 40 provides the predicted route database with a predicted route obtained by using Dijkstra's algorithm E. W. Dijkstra, “A note on two problems in connection with graphs”, Numer.Math., 1 (1959), PP.269-271 and the like using network apparatus connection information.

Next, the network management system 40 receives a message to check permission of control by a control IP packet arrival at the step S86, and determines whether or not this control permission checking message is a first message (control permission checking message from a communication apparatus to which a source terminal is connected) at the step S88. And only when it is not the first message, a counter is incremented at the step S88. That is, the count value of the counter increases, as a difference between the predicted route and an actual route grows large.

Then, the control permission database of a structure as shown in FIG. 3 is searched by this control permission checking message at the step S92. Upon checking an address of a source terminal, an address of a destination terminal and a control ID, whether or not the control is permissible is determined in this search at the step 94. If it is not permissible, a response message of control disapproval is transmitted at the step S96.

Further, if permissible, a predicted route database is searched at the step S98, and a response message of control permission is transmitted at the step S100. Next, a response message of the control permission by this control IP packet is transmitted to communication apparatuses on a control IP packet transmitting route down to the destination terminal 30, which is predicted at the step S102 (predicted route).

Next, whether the counted value of the counter is over the predetermined threshold, is checked at the step S104. If it is not over, the process progresses to the step S86. If the counted value of the counter exceeds the threshold, the process progresses to the step S80. At the step S80, the counter is reset to 0. Subsequently, at the step S82, IP packet routing information in the communication apparatus, defined by IETF RFC201 “SNMPv2 Management Information Base for the Internet Protocol using SMIv2” and the like is read by using IETF RFC1905 “Protocol Operation for Version 2 of the Simple Network Management Protocol” (SNMPv2) and the like. First candidates of next hop is connected to configure a route that is treated as the predicted route and stored in the predicted route database at the step S84.

That is, initially, the predicted route is set up by Dijkstra's algorithm using the network apparatus connection information, and when a difference between the predicted route and an actual route grows large and the counted value exceeds the threshold, the predicted route database is updated, so that it is inline with the actual route. In this manner, route prediction with a high precision in accordance with prevailing network conditions is then attained, dispensing with a read-out of information from a communication apparatus in the beginning.

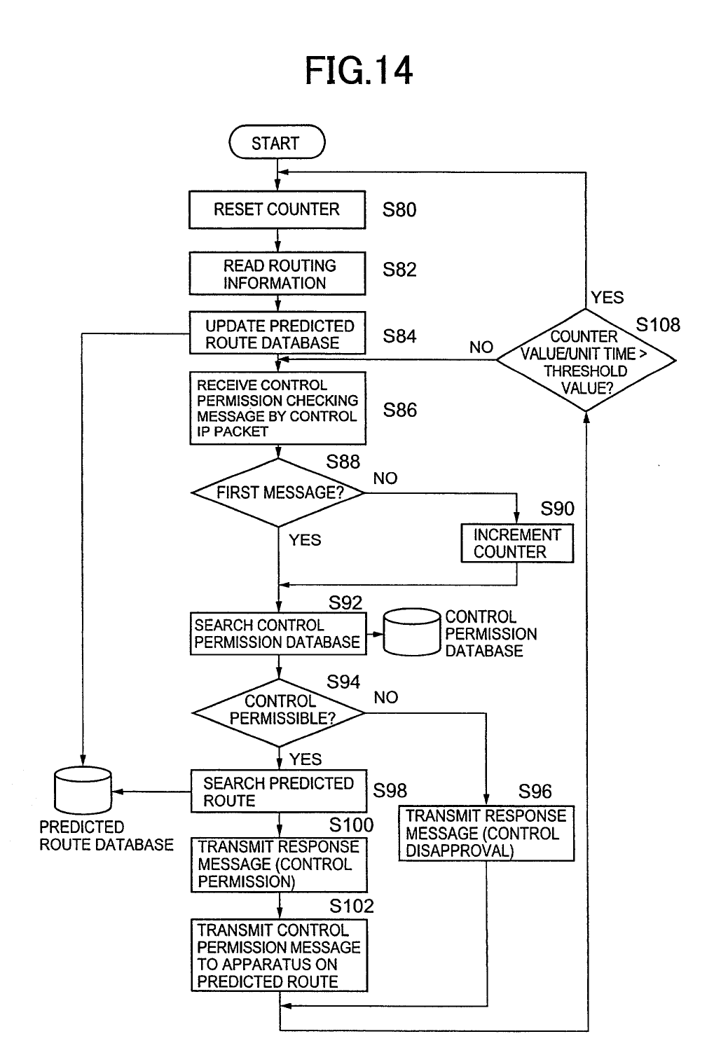

FIG. 14 shows a flowchart of the fourth embodiment of the control processing which the network management system 40 performs. In the drawing, the same reference number is given to the same step as in FIG. 12.

In FIG. 14, the network management system 40 initially resets the counter to 0 at the step S80. Next, at the step S82, IP packet routing information in a communication apparatus, defined by IETF RFC2011 “SNMPv2 Management Information Base for the Internet Protocol using SMIv2” and the like is read by using IETF RFC1905 “Protocol Operation for Version 2 of the Simple Network Management Protocol” (SNMPv2) and the like. At the step S84, candidates of next hop are connected to configure a route that is treated as the predicted route and stored in the predicted route database.

Next, at the step S86, the network management system 40 receives the checking message of control permission by control IP packet arrival, and determines whether this control permission checking message is the first message (control permission checking message from the communication apparatus to which the source terminal is connected) at the step S88. Only when it is not the first message, the counter increments a count at the step S90. That is, the count value of the counter increases s a difference between the predicted route and an actual route grows large.

Then, the control permission database of a structure as shown in FIG. 3 is searched by this control permission checking message at the step S92. Upon checking an address of a source terminal, an address of a destination terminal and a control ID, whether the control is permitted is determined in this search at the step S94. If the control is not permitted, a response message of control disapproval is transmitted at the step S96.

If the control is permissible, the predicted route database is searched at the step S98, and a response message of control permission is transmitted at the step S100.

Next, the response message of the control permission by this control IP packet is transmitted to communication apparatuses on a transmitting route (predicted route) of the control IP packet to a terminal 30, which is predicted at the step S102.

Next, at the step S108, it is checked whether a quotient of the counted value of the counter divided by unit time exceeds a predetermined threshold. When the quotient does not exceed the threshold, the process progresses to the step S86. When the quotient exceeds the threshold, the process progresses to the step S80. That is, when the quotient of the counted value divided by unit time exceeds the threshold value due to the difference between the predicted route and an actual route becoming large, the predicted route database is updated so that it is in line with the actual route.

Thus, when the quotient of the counted value divided by unit time exceeds the threshold due to the difference between the predicted route and the actual route becoming large, the route prediction database is updated to be in line with the actual route, thereby, a high precision route prediction according to prevailing network conditions is then attained.

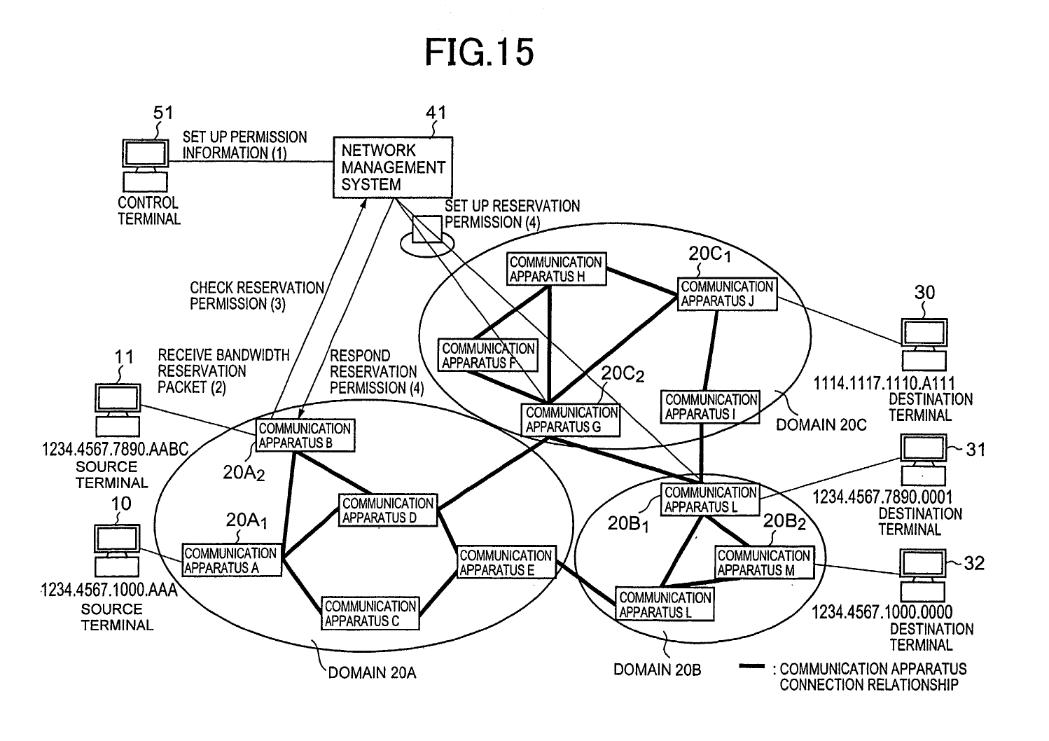

FIG. 15 shows a system configuration and operation of the fifth embodiment of the method in this invention. In the drawing, a network includes a plurality of domains 20A, 20B, and 20C. Source terminals 10 and 11 are connected to communication apparatuses 20A₁ and 20A₂, respectively, in the domain 20A.

Further, a destination terminal 30 is connected to a communication apparatus 20C₁ in the domain 20C. Destination terminals 31 and 32 are connected to communication apparatuses 20B₁ and 20B₂, respectively, in the domain 20B. Each domain manages the communication apparatuses in its respective domain autonomously, and the domains 20A, 20B, and 20C included in the network are managed by a network management system 41. A control terminal 51 sets up control permission information of a control IP packet of the network management system 41.

In a configuration such as above, when a control IP packet goes into a different domain, the communication apparatus 20B₁, and a communication apparatus 20C₂, for example, each at a gateway of a domain, which receive the control IP packet, check with the network management system 41 about permission of control. Then, the information that permission is granted is written into a predetermined bit in the control IP packet by the communication apparatuses 20B₁ and 20C₂ at the gateway, to which control permission has been sent from the network management system 41.

Further, each communication apparatus in a domain sets up permission based on information in the control IP packet that permission is granted. Further, the network management system 41 sets permission of control to the communication apparatuses 20B₁, and 20C₂, each at the gateway of its respective domain, which are on a predicted route, from the network management system 41.

When a control packet is transmitted from the source terminal 10 with an IP address “1234.4567.7890.AABC” to a destination terminal 31 with an IP address “1234.4567.7890.0001”, the network management system 41 sets up permission of control to the communication apparatuses 20C₂ and 20B₁, at the gateway of the domains 20C and 20B on the predicted route (for example, the minimum hop) of the control packet. In this manner, the effort spent on the permission check of the control generated when the control packet is transmitted to a different domain is reduced.

In a related matter, in the control processing which the network management system 40 shown in FIG. 2 performs, when-a second or later check of the permission of control from the same control IP packet is performed by the network management system 40, permission of control by the control IP packet is set at other communication apparatuses on a transmitting route of the control IP packet, the-transmitting route being from the communication apparatus which checked permission of control for the second or later time and having been predicted.

For example, when the control IP packet is transmitted from the source terminal 10 in the system shown in FIG. 1, and the communication apparatus 21 receives the control IP packet, the network management system 40 receives the checking message of the permission of a setup of the control from the communication apparatus 21, searches data about the permission of control by the control IP packet and returns a permission message of control to the communication apparatus 21, while the permission message of control by the control IP packet is transmitted also to the communication apparatuses 22 and 23 on the predicted route.

In the case that the second or later check of the permission of the control by the same control IP packet is performed by the network management system 40 by a communication apparatus 24 that is not on the predicted route, a permission message of control is returned to the communication apparatus 24 from the communication apparatus 24, while the permission message of control by the control IP packet is also transmitted to the communication apparatuses 25 and 23 on the predicted route down to the destination terminal 30.

In this manner, when the first prediction was wrong and the second or later prediction was correct, generating of the checking message of the permission to the control IP packet from the communication apparatus 25 and the like on the predicted route is prevented.

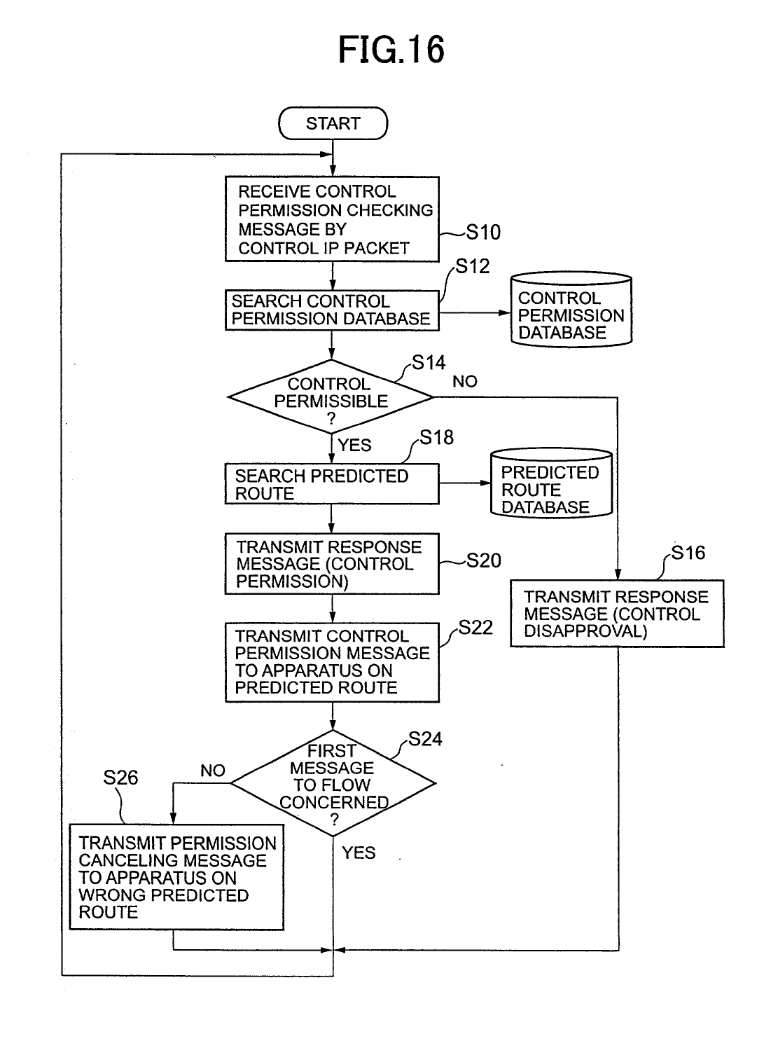

FIG. 16 shows a flowchart of the sixth embodiment of the control processing which the network management system 40 performs. In the drawing, the same reference number is given to the same step as in FIG. 2.

In FIG. 16, at the step S10, the network management system 40 receives the control permission checking message by control IP packet arrival and searches the control permission database by this control permission checking message at the step S12. Upon checking an address of a source terminal, an address of a destination terminal and a control ID, whether control is permissible is determined at the step S14. If the control is not permissible, a response message of control disapproval is transmitted at the step. S16.

Further, if the control is permissible, a predicted route database is searched at the step S18, and a response message of control permission is transmitted at the step S20. Next, the response message of the control permission by this control IP packet is transmitted to communication apparatuses on a transmitting route (predicted route) of the control IP packet down to the destination terminal, which is predicted at the step S22.

Then, at the step S24, whether the control permission checking message by the control IP packet is the first message (control permission checking message from the communication apparatus to which the source terminal is connected) is determined. Here, if it is not the first message, the process progresses to the step S26 wherein a message that cancels the control permission by this control IP packet is transmitted to the communication apparatus on the route predicted upon receiving the previous control permission checking message reception (namely, the route prediction which is wrong).

In this manner, reduction is realized in a capacity required for storing the setting information on the control permission in each communication apparatus.

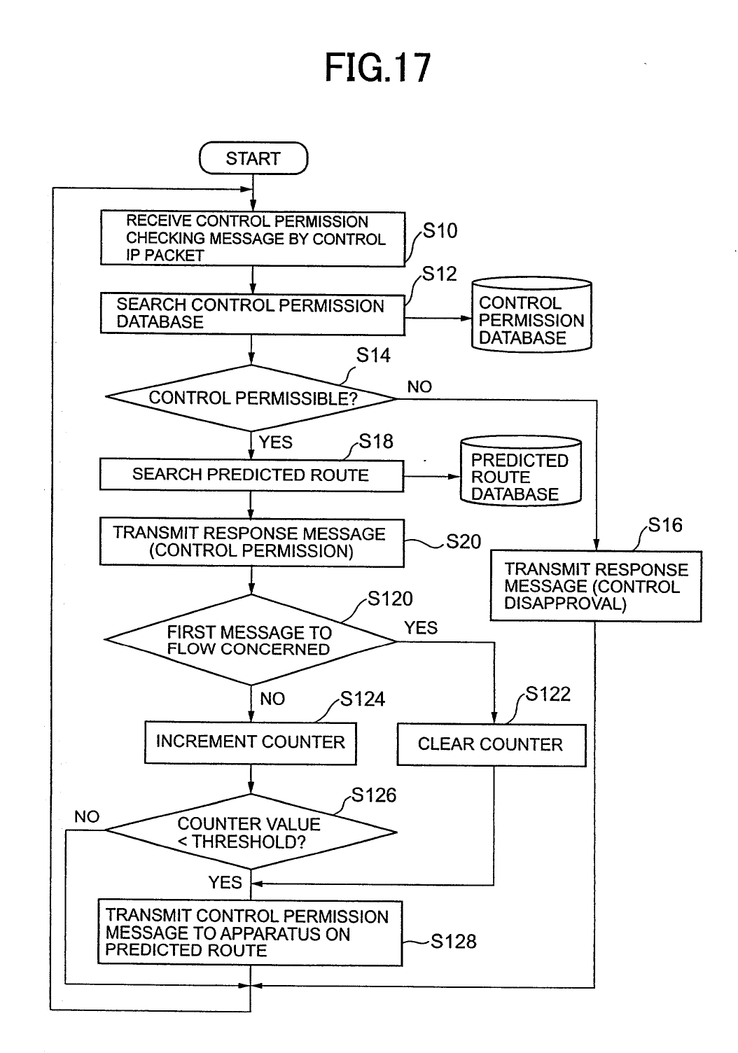

FIG. 17 shows a flowchart of the seventh embodiment of the control processing that the network management system 40 performs. In the drawing, the same reference number is given to the same step as in FIG. 2.

In FIG. 17, the network management system 40 receives the control permission checking message by control IP packet arrival by the step S10, and searches the control permission database by this control permission checking message at the step S12.

Upon checking an address of a source terminal, an address of a destination terminal and a control ID, whether the control is permissible is determined at the step S14. If the control is not permissible, a response message of control disapproval is transmitted at the step S16.

Further, if the control is permissible, the predicted route database is searched at the step S18, and a response message of control permission is transmitted at the step S20. Next, the response message of the control permission by this control IP packet is transmitted to communication apparatuses on the transmitting route (predicted route) of the control IP packet down to the destination terminal 30, which is predicted at the step S22.

Then, whether the control permission checking message by the control IP packet concerned is the first message is determined at a step S120. Here, if it is the first message, the counter is cleared to zero at a step S122, and the process progresses to a step S128, and transmits the response message of the control permission by this control IP packet to the communication apparatuses on the predicted transmitting route (predicted route) of the control IP packet down to the destination terminal.

If it is not the first message, the process progresses to a step S124, and a counter is incremented. Then, whether the counted value of the counter is less than a predetermined threshold is determined, and only when the counted value is less than the threshold, a response message of the control permission by this control IP packet is transmitted to other communication apparatuses that exist on the predicted route corrected by a step S128.

In this manner, if the number of checking messages of the control permission from the same control IP packet exceeds a fixed number of times, that is, if the counted value exceeds the threshold value, due to the actual route being different from the predicted route, setting up permission of control by the control IP packet by prediction is not performed, thereby, it becomes possible to prevent an increase in the number of setting messages based on a low precise prediction.

Here, when set-up permission of control by the control IP packet by prediction is not performed, each communication apparatus transmits a control permission checking message to the network management system as usual upon receiving a control IP packet in this communication apparatus.

According to this invention, an amount of processing, such as search and updating of the database in the network management system, can be reduced, the number of checking messages from a communication apparatus that receives a control IP packet can be reduced, and control permission to control IP packets can be checked at a high speed. In this manner, service quality, e.g., by RSVP and the like based on control by the control IP packet can be improved.

What is claimed is:

1. A network management method wherein a network management system manages permission of control when the control of a communication apparatus in a network is performed by transmitting a control IP packet, comprising:
preparing a predicted route through which the control IP packet is to be transmitted, by the network management system,
checking the permission of control, by a communication apparatus that has received the control IP packet, and
setting up the permission of control to the communication apparatus and setting up the permission of control to other communication apparatuses on the predicted route through which the control IP packet is to be transmitted by notifying a checking result to the network management system, if the control IP packet is to be permitted.

2. The network management method as claimed in claim 1, wherein, a shortest route from the communication apparatus that has checked the permission of control to a destination terminal is used as the predicted route through which the control IP packet is to be transmitted, the shortest route being obtained from connecting relations among each of the communication apparatuses in the network.

3. The network management method as claimed in claim 1, wherein, a plurality of routes from the communication apparatus that have checked the permission of control to a destination terminal are used in a preferential order of a distance starting with the shortest route, as the predicted route through which the control IP packet is to be transmitted, the routes being obtained from connecting relations among each of the communication apparatuses in the network.

4. The network management method as claimed in claim 1, wherein, a route configured by connecting primary candidates of a next hop in IP packet routing information read out from the communication apparatus is used as the predicted route through which the control IP packet is to be transmitted.

5. The network management method as claimed in claim 1, wherein, routes configured by connecting a plurality of next hops sequentially from the primary candidate in the IP packet routing information read out from the communication apparatus are used in a preferential order starting with the route configured by connecting the primary candidates of the next hop, as the predicted route through which the control IP packet is to be transmitted.

6. In the network management method as claimed in claim 5, wherein a route, among the routes configured by connecting the plurality of the next hops sequentially from the primary candidate in the IP packet routing information read out from the communication apparatus, which includes more than a predetermined number of next hops other than the primary candidate, is excluded from the predicted route.

7. The network management method as claimed in claim 2, wherein
a number indicative of how many times a second or later checking of the permission of control was performed by a communication apparatus that had received an identical control IP packet is counted by the network management system, and
when a value of this counting exceeds a predetermined value, a route configured by connecting the primary candidates of next hop read out from the IP packet routing information of the communication apparatus is used as the predicted route through which the control IP packet is to be transmitted.

8. The network management method as claimed in claim 4, wherein
a number indicative of how many times a second or later checking of the permission of control was performed from a communication apparatus that had received an identical control IP packet is counted by the network management system, and
when a value of this counting exceeds a predetermined value, the predicted route is updated by reading out the IP packet routing information from the communication apparatus.

9. The network management method as claimed in claim 4, wherein
a number indicative of how many times a second or later checking of the permission of control was performed from a communication apparatus that had received an identical control IP packet is counted by the network management system, and
when a value of this counting in unit time exceeds a predetermined value, the predicted route is updated by reading out the IP packet routing information from the communication apparatus.

10. The network management method as claimed in claim 1 in the case that the network includes a plurality of domains, wherein
a communication apparatus at a domain gateway on a predicted route, which has received the control IP packet, checks the permission of control with the network management system,
information that permission is granted is written in the control IP packet by the communication apparatus at the gateway, to which permission of control has been set, and
the permission of control is set up in communication apparatuses in the domain based on the information that the permission is granted.

11. The network management method as claimed in claim 1, wherein
the network management system, upon being checked for a second or later time about permission by a communication apparatus for an identical control IP packet, sets up permission of control to the communication apparatus that has checked for the permission and sets up permission of control to other communication apparatuses on a renewed predicted route, through which the control IP packet, is to be transmitted, if the control IP packet is to be permitted.

12. The network management method as claimed in claim 11, wherein the network management system, upon being checked for a second or later time about permission by a communication apparatus regarding an identical control IP packet, cancels the permission of control to the communication apparatus on the predicted route, on and after the apparatus which executed a second or later check, to which permission of control was set up by a previous check.

13. The network management method as claimed in claim 1, wherein
a number indicative of how many times second or later checking of the permission of control from the communication apparatus regarding an identical control IP packet was performed is counted by the network management system, and
when a value of this counting exceeds a predetermined value, permission of control is set up in the communication apparatus that has checked the permission of the control, if the control IP packet is permitted to control, while a setup of the permission of control in other communication apparatuses on the predicted route through which the control IP packet is to be transmitted is cancelled.
